(19) United States
(12) Patent Application Publication
(10) Pub. No.: US 2008/0044796 A1
(43) Pub. Date: Feb. 21, 2008

(54) A TEETH WHITENING SYSTEM AND A METHOD FOR WHITENING TEETH

(75) Inventor: Andy Hsu, Beijing (CN)

Correspondence Address: DOVAS LAW P.C., 307 BAINBRIDGE STREET, PHILADELPHIA, PA, 19147, US

(73) Assignee: BEYOND TECHNOLOGY CORP., Sunnyvale, CA (US)

(21) Appl. No.: 11/465,464

(22) Filed: Aug. 18, 2006

(51) Int. Cl. A61C 5/00

(52) U.S. Cl. 433/215

(57) ABSTRACT

A system for whitening teeth is provided. The system includes a whitening composition including an oxidizing compound for application onto teeth of a user. A cheek retractor for opening lips of a user to facilitate application of the whitening composition onto teeth of a user is included in the system. A light source is adjustably or removably connectable to the cheek retractor for shining light onto teeth of a user. A device for irradiating the surface of teeth and a method for whitening teeth are also provided.

### BACKGROUND

It is generally acknowledged that whiter teeth are desirable and darker or stained teeth are less than desirable. Unfortunately, there are numerous substances, including food and tobacco products, which can darken or stain the teeth. Initially, such substances may accumulate on the outer enamel layer of the teeth forming a film. Eventually however, stain carrying substances may permeate the tooth enamel causing discoloration which cannot be removed by brushing, scraping or any mechanical process.

Different methods of chemically removing teeth stains are known. Many of these methods rely on a peroxide or other whitening active disposed in a whitening composition which whitens the teeth by penetrating the tooth enamel and bleaching the stains. Known methods of removing teeth stains typically require a whitening composition with a high concentration of peroxide or other whitening active to effect noticeable teeth whitening. This high concentration of whitening active is often undesirable due to potential tooth sensitivity and other discomfort caused to a user of the whitening composition. Alternatively, lower concentrations of peroxide or other whitening active can be used in a whitening composition if the composition is to be left to remain in contact with the teeth for a longer period of time. Often however, a user still experiences a level of discomfort during the process.

Some known methods of whitening teeth also employ a light source for shining on a whitening composition in an effort to accelerate the bleaching process. Such light sources may be ineffective or otherwise large, expensive and not suitable for use by an individual without assistance. Using known methods, safe and effective teeth whitening is typically difficult to achieve without the assistance of a dental professional.

In view of the above, it would be desirable to provide a teeth whitening system and a method for whitening teeth which can be employed by an individual alone without assistance in a home environment. It is preferred that such a system be affordable as well as straight forward and easy to use to allow for consistent results with each user.

### SUMMARY

The present invention provides a system for whitening teeth which includes a whitening composition including an oxidizing compound for application onto teeth of a user. A cheek retractor for opening lips of a user to facilitate application of the whitening composition onto teeth is included in the system. A light source is adjustably or removably connectable to the cheek retractor for shining light onto teeth of a user.

The present invention also provides a device for irradiating teeth which includes a cheek retractor for opening lips of a user and a light source which is removably or adjustably connected to the cheek retractor for shining light onto teeth of a user.

The present invention further provides a method for whitening teeth of a user. The method includes providing a cheek retractor, a light source and a tooth whitening composition. Cheeks of a user are retracted with the cheek retractor to expose the teeth of the user. Tooth whitening composition is applied to the teeth of the user exposed by the cheek retractor. The light source is removably connected to the cheek retractor and light is shone from the light source onto the teeth of the user exposed by the cheek retractor.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a front elevation view of a cheek retractor and a light source, in connection therewith, of a teeth whitening system according to a preferred embodiment of the present invention.

FIG. 2 is a rear elevation view of the connected cheek retractor and light source of FIG. 1.

FIG. 3 is a side elevation view of the connected cheek retractor and light source of FIG. 1.

FIG. 4 is a rear elevation view of the connected cheek retractor and light source of FIG. 1, and further showing a battery housing of the teeth whitening system.

FIG. 5A is a perspective view of a sealed pouch for storing a film and an activation composition of the teeth whitening system according to a preferred embodiment of the present invention.

FIG. 5B is a perspective view of the sealed pouch of FIG. 5A shown open and revealing the film.

FIG. 5C is a perspective view of a container for storing whitening composition of the teeth whitening system according to a preferred embodiment of the present invention.

FIGS. 6A-6E show pictorial steps of a preferred procedure for utilizing the teeth whitening system of FIGS. 1-4 and 5A-5C.

FIG. 7 is a diagram showing a method of whitening teeth according to a preferred embodiment of the present invention.

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

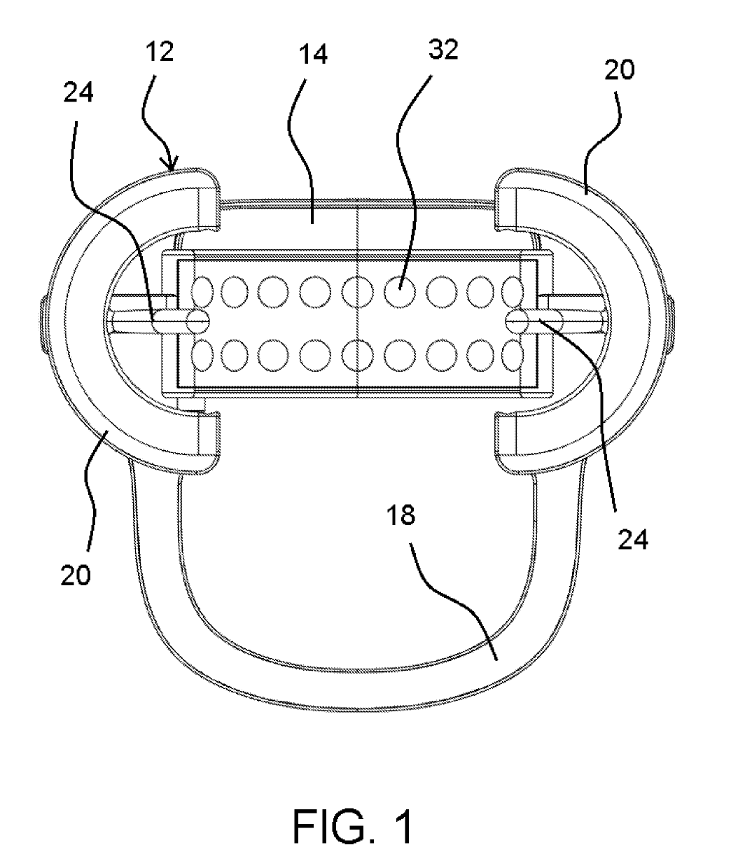

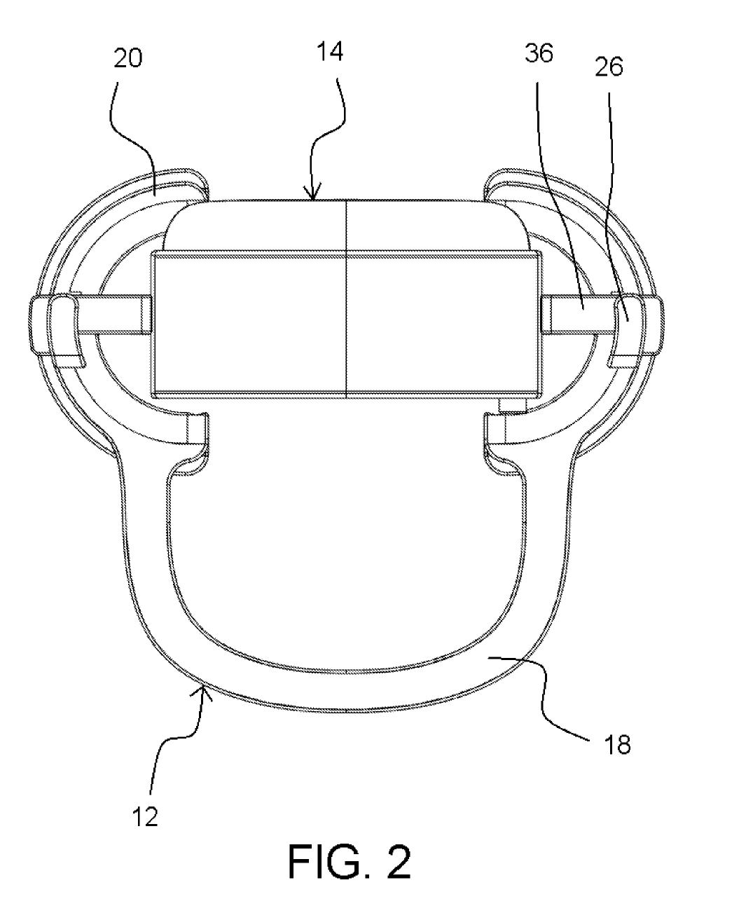

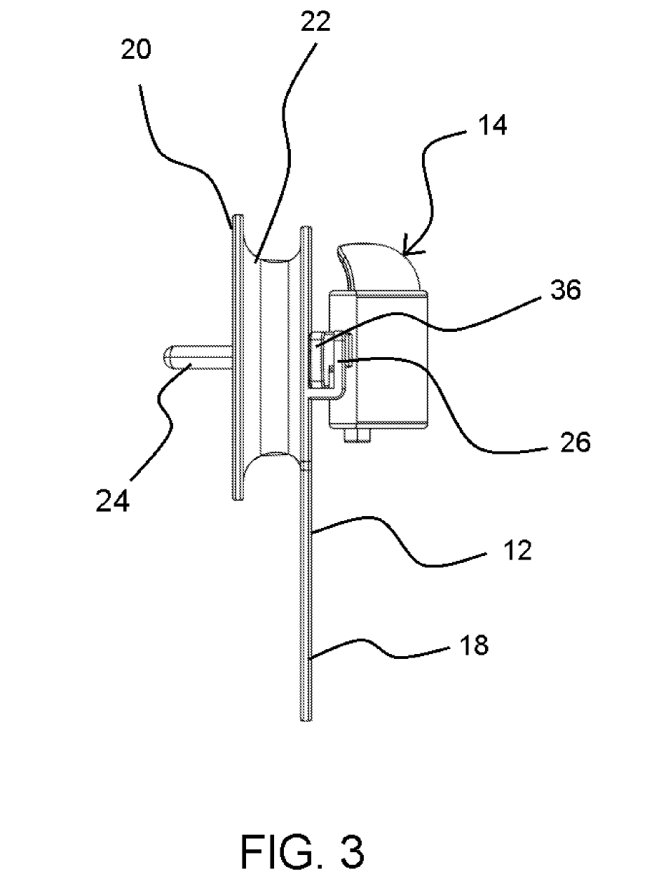

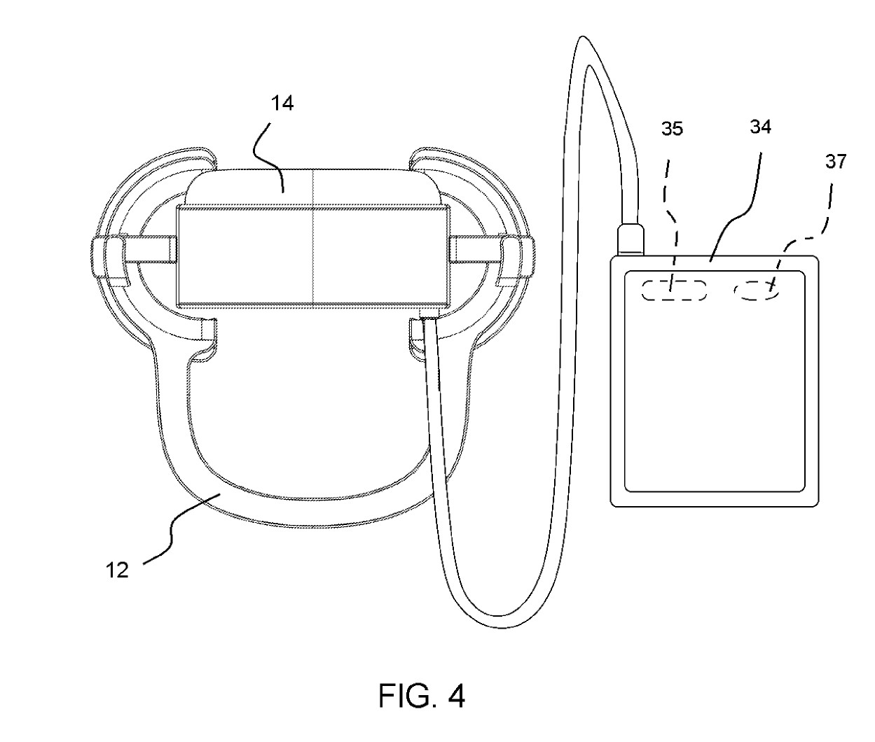

Referring to FIGS. 1-4 and 5A-5C, components of a system for whitening teeth according to a preferred embodiment of the present invention are shown. The system includes a whitening composition for application onto a user's teeth, a cheek retractor 12 for opening lips of a user, and a light source 14 removably connected to the cheek retractor 12 for shining light onto teeth of a user.

The whitening composition is preferably in the form of a liquid, gel or paste and includes an oxidizing compound which is preferably hydrogen peroxide. The hydrogen peroxide is preferably included in an amount in a range of about 3% to about 12% by weight of the composition. More preferably, the hydrogen peroxide is included in an amount of about 7%. Alternatively, the oxidizing compound can include carbamide peroxide, alkali metal peroxides, alkali metal percarbonates, alkali metal perborates, or any suitable oxidizing compound or combination of oxidizing compounds.

The whitening composition includes a carrier which preferably includes propanediol and deionized water. The propanediol is preferably included in an amount in a range of about 15% to about 60% by weight of the composition. More preferably, the propanediol is included in an amount in a range of about 30% to about 50% by weight of the composition. Most preferably, the propanediol is included in an amount of about 40% by weight of the composition. Alternatively, the carrier can include propanetriol, glycerin, propylene glycols, polyethylene glycol, polypropylene glycol, polyethylene oxide, sorbitol, mannitol, eryrthritol, stearyl alcohol, other alcohols, other polyols, or any suitable carrier or combination of carriers.

Preferably, the whitening composition includes a thickener. The thickener preferably includes carbomer in an amount in a range of about 1% to about 5% by weight of the composition. More preferably, the carbomer is included in an amount in a range of about 2% to about 3% by weight of the composition. Most preferably, the carbomer is included in an amount of about 2.5% by weight of the composition. Alternatively, any suitable thickener, for example fused silica, can be provided instead of or in addition to the carbomer.

The whitening composition preferably includes a neutralizer. The neutralizer preferably includes sodium hydroxide in an amount in a range of about 0% to about 0.5% by weight of the composition. More preferably, the sodium hydroxide is included in an amount of about 0.05% by weight of the composition. Alternatively, any suitable neutralizer can be provided.

Further, the whitening composition preferably includes one or more stabilizers. Preferably, the whitening composition is provided with one or more of the following stabilizers in the following amounts: EDTA in a range of about 1% to about 5%, acetanilide in a range of about 0.001% to about 0.5%, quinine hydrochloride in a range of about 0.001% to about 0.5%, Emulsifier MOA-9 in a range of about 0.01% to about 5%, and Scale Inhibitor and Dispersant TS-104 in a range of about 0.01% to about 5%. More preferably, the whitening composition is provided with one or more of the following stabilizers in the following amounts: EDTA in a range of about 1% to about 5%, acetanilide in a range of about 0.01% to about 0.1%, quinine hydrochloride in a range of about 0.01% to about 0.1%, Emulsifier MOA-9 in a range of about 0.1% to about 1.5%, and Scale Inhibitor and Dispersant TS-104 in a range of about 0.01% to about 0.15%. Most preferably, the whitening composition includes the following combination of stabilizers: EDTA in an amount of about 1.5%, acetanilide in an amount of about 0.05%, quinine hydrochloride in an amount of about 0.03%, Emulsifier MOA-9 in an amount of about 1.0%, and Scale Inhibitor and Dispersant TS-104 in an amount of about 0.08%. Alternatively, the whitening composition can be provided with one or more other suitable stabilizers, and/or provided with other suitable combinations of one or more of the above-specified stabilizers.

Referring to Table 1 below, a non-limiting example is provided of a whitening composition according to a preferred embodiment of the present invention.

TABLE 1

| Ingredient | Percentage | | Chemical | |
|---|---|---|---|---|
| Name | (%) | Grade | Structure | Performance |
| 1,2- | 40 | AR | C₃H₆O₂ | Inert carrier |
| propanediol | | | | |
| carbomer | 2.5 | Cosmetic | (C₃H₄O₂)ₙ | thickener |
| | | grade | | |
| hydrogen | 7 | AR | H₂O₂ | Active ingredients |
| peroxide | | | | |
| sodium | 0.05 | AR | NaOH | neutralizer |
| hydroxide | | | | |
| EDTA-2Na | 1.5 | AR | C₁₀H₁₄Na₂O₄.2H₂O | stabilizer |
| Acetanilide | 0.05 | CP | C₁₀H₁₁NO₂ | stabilizer |
| Quinine | 0.03 | Drug grade | C₂₀H₂₄O₂N₂.HCl.2H₂O | stabilizer |
| hydrochloride | | | | |
| Emulsifier | 1.0 | Cosmetic | RO(C₂H₄O)₉HR═C₁₂—C₁₆ | stabilizer |
| MOA-9 | | grade | | |
| Scale Inhibitor/ | 0.08 | CP | C₂H₈O₇P₂ | stabilizer |
| Dispersant TS- | | | | |
| 104 | | | | |
| deionized | remainder | ≧1 million Ω · cm | H₂O | Inert carrier |
| water | | | | |

In the whitening system, the whitening composition is preferably provided in a container 16 having a brush 18 for application of the whitening composition onto teeth of a user. Alternatively, the whitening composition can be provided in any suitable container for dispensing in any suitable manner.

An activation composition is preferably provided for application onto the whitening composition to enhance the effectiveness of the whitening composition when applied to teeth of a user. The activation composition accelerates the breakdown of oxidizing compounds to quickly release active oxygen thereby accelerating teeth whitening. The activation composition preferably comprises a metallic oxide activator. Preferably, the metallic oxide activator is a manganese oxide activator included in an amount in a range of about 0.001% to about 5% by weight of the composition. More preferably, the manganese oxide activator is included in an amount in a range of about 0.01% to about 0.15% by weight of the composition. Most preferably, the manganese oxide activator is included in an amount of about 0.05%. Alternatively, the activation composition can include any suitable activator for accelerating the decomposition of an oxidizing compound.

The activation composition includes a carrier which preferably includes propanetriol and deionized water. The propanetriol is preferably included in an amount in a range of about 15% to about 70% by weight of the composition. More preferably, the propanetriol is included in an amount in a range of about 40% to about 70% by weight of the composition. Most preferably, the propanetriol is included in an amount of about 65% by weight of the composition. Alternatively, the carrier can include propanediol, glycerin, propylene glycols, polyethylene glycol, polypropylene glycol, polyethylene oxide, sorbitol, mannitol, eryrthritol, stearyl alcohol, other alcohols, other polyols, or any suitable carrier or combination of carriers.

Preferably, the activation composition includes a thickener. The thickener preferably includes carbomer in an amount in a range of about 1% to about 5% by weight of the composition. More preferably, the carbomer is included in an amount of about 1.5% by weight of the composition. Alternatively, any suitable thickener, for example fused silica, can be provided instead of or in addition to the carbomer.

Preferably, the activation composition includes an antiseptic. The antiseptic preferably includes sodium benzoate in an amount in a range of about 0.1% to about 0.5% by weight of the composition. More preferably, the sodium benzoate is included in an amount in a range of about 0.1% to about 1.5% by weight of the composition. Most preferably, the sodium benzoate is included in an amount of about 0.1% by weight of the composition. Alternatively, any suitable antiseptic can be provided instead of or in addition to the sodium benzoate.

Preferably, the activation composition includes a photocatalyst to convert incident radiation into heat to accelerate the release of active oxygen from the oxidizing compound in the whitening composition. The photocatalyst preferably includes titanium dioxide in an amount in a range of about 0.1% to about 5.0% by weight of the composition. More preferably, the titanium dioxide is included in an amount in a range of about 0.1% to about 2.0% by weight of the composition. Most preferably, the titanium dioxide is included in an amount of about 0.7% by weight of the composition. Alternatively, any suitable photocatalyst can be provided instead of or in addition to the titanium dioxide. It should also be noted that other components of the activation composition, for example the activator, may also have photocatalyzing qualities.

Referring to Table 2 below, a non-limiting example is provided of a whitening composition according to a preferred embodiment of the present invention.

TABLE 2

| | Per- | | | |
|---|---|---|---|---|
| | cent- | | | |
| Ingredient | age | | Chemical | |
| Name | (%) | Grade | Structure | Performance |
| propanetriol | 65 | AR | C₃H₈O₃ | Inert carrier |
| carbomer | 1.5 | Cosmetic | (C₃H₄O₂)ₙ | thickener |
| | | grade | | |
| manganese | 0.05 | AR | MnOₓ | activator |
| activator | | | | |
| sodium | 0.1 | AR | C₇H₅O₂Na | antiseptic |
| benzoate | | | | |
| photocatalyst | 0.7 | Electronic | TiO₂ | photocatalyzer |
| | | chemicals | | |
| deionized water | re- | ≧1millionΩ · cm | H₂O | Inert carrier |
| | main- | | | |
| | der | | | |

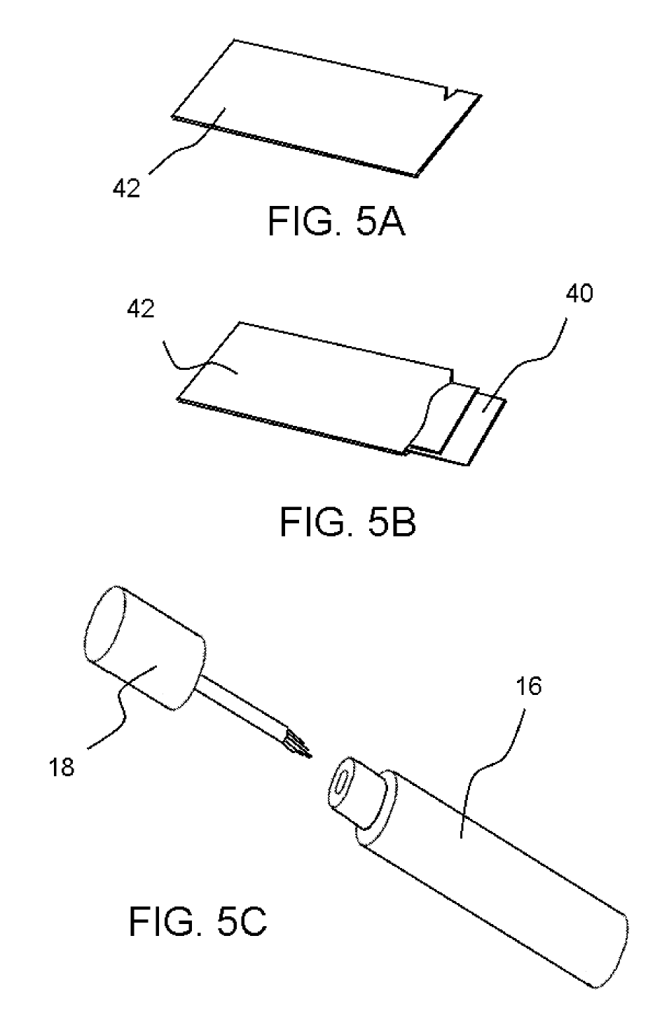

Referring to FIGS. 5A and 5B, the activation composition is preferably disposed as a viscous liquid layer in contact with a film 40 which is packaged in a hermetically sealed pouch 42 prior to use. Alternatively, the activation composition can be a gel, a semi-liquid, or solid depending on the components which it is comprised of. In a preferred manner of use, the pouch 42 is opened as shown in FIG. 5B, and one or more of the films 40, with the activation composition disposed thereon, are removed and applied to teeth of a user in contact with previously applied whitening composition. The film 40 is preferably a polymeric film, and more preferably a substantially transparent polymeric film. Alternatively, the film 40 can be a metallic film or any substantially flexible film.

The cheek retractor 12 preferably includes a spring portion 18 and two lip contact portions 20 connected to the spring portion 18 which are outwardly biased by the spring portion 18. The lip contact portions 20 are preferably arcing and include curved channels 22 for receiving the lips of a user. The spring portion 18 is a linear spring. Alternatively, any suitable spring can be used for outwardly biasing the lip contact portions or the spring could be replaced with a rigid or substantially rigid member. Bite spacers 24 are preferably provided for separating top and bottom rows of a user's teeth. Extending portions 26 of the cheek retractor 12 function to removably receive complementary extending portions 36 of the light source 14. Alternatively, other suitable connecting portions may be provided to removably connect the cheek retractor 12 to the light source 14. Alternatively, one or more of the extending portions 26, 36 can be provided to function as pivotable or movable connections to permit an adjustable connection between the cheek retractor 12 and the light source 14. The cheek retractor 12 is preferably constructed from polymeric material. However, any suitable material or materials can alternatively be used to form the cheek retractor 12.

The light source 14 preferably includes a plurality of light emitting diodes (LEDs) which emit light having a wavelength in a range between about 450 nm and 510 nm for shining light onto teeth of a user. More preferably, the light source 14 includes LEDs 32 which emit light having a wavelength in a range between about 470 nm and 490 nm. An example of a preferred LED for use in the light source 14 is an InGaN LED having a maximum power dissipation of 100 mW, a peak forward current of 100 mA, a maximum continuous forward current of 20 mA, a luminous intensity in the range of about 1000 to about 1500 mcd, and a forward voltage in the range of about 3.0 V minimum to about 3.4 V maximum. Alternatively, the light source 14 can be provided with other suitable light emitters, for example incandescent, fluorescent, or halogen type light emitters. A power unit 34 having at least one battery is preferably provided to power the light source 14. Alternatively, the light source can be powered in any suitable manner including using line-supplied power. The light source 14 is preferably constructed substantially from polymeric material. However, any suitable material or materials can alternatively be used to form the light source 14.

The power unit 34 includes a timer 35 and an audible alarm 37 connected to the timer 35 for indicating to a user when a treatment procedure is complete. Preferably, the timer 35 is permanently preset for a predetermined time period of 20 minutes. Alternatively, other suitable time periods can be permanently preset or user selected.

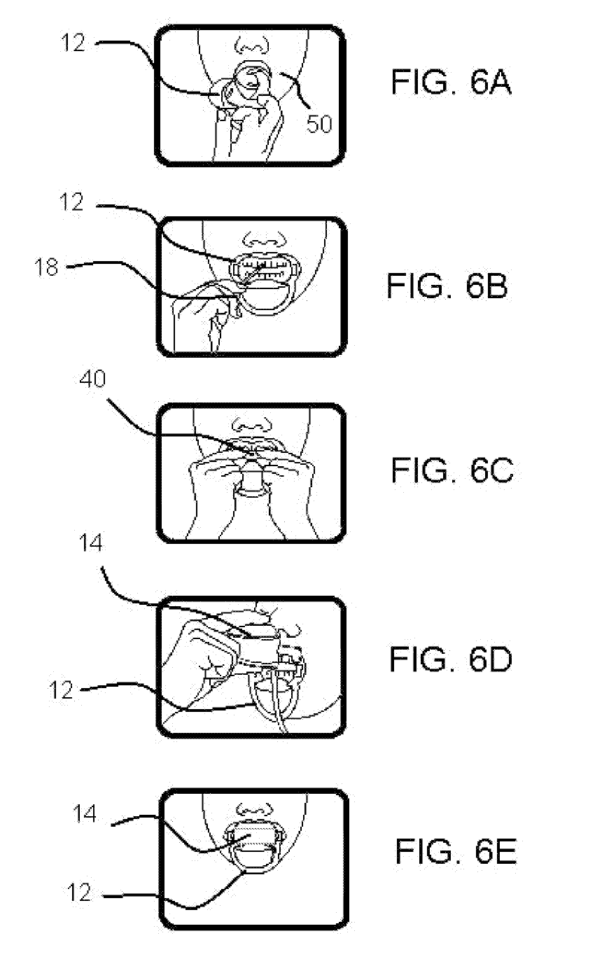

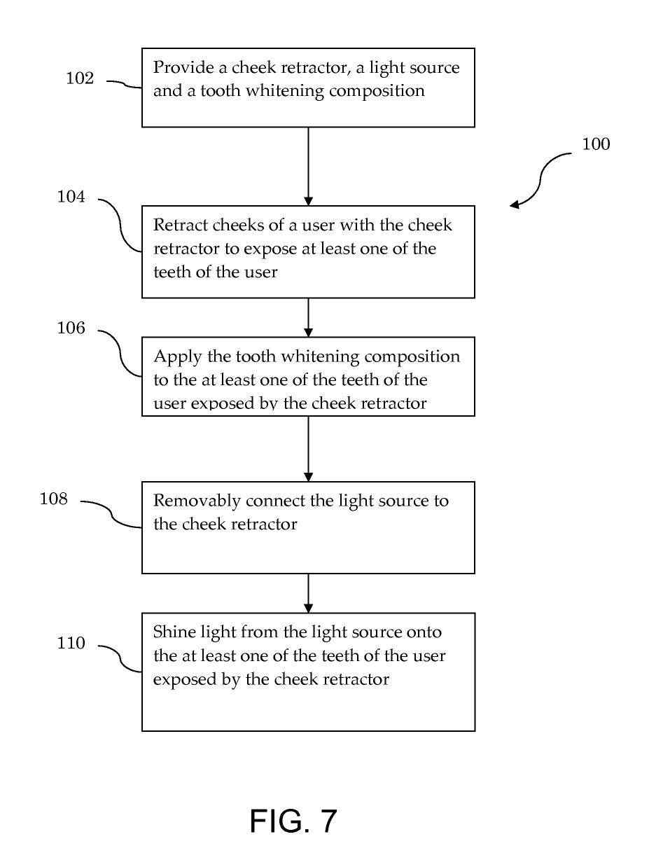

Referring to FIG. 7, a method 100 for whitening teeth is described and shown. For convenience, the method 100 for whitening teeth is described with reference to the tooth whitening system shown in FIGS. 1-4 and 5A-5C, and also with reference to FIGS. 6A-6E which show pictorial steps of a preferred procedure for utilizing the teeth whitening system of FIGS. 1-4 and 5A-5C. However, the method 100 is not limited to the embodiments shown in FIGS. 1-4, 5A-5C, and 6A-6E, or to any particular system or any particular system components.

The method 100 includes providing a cheek retractor 12, a light source 14 and a tooth whitening composition (step 102). As shown in FIGS. 6A and 6B, the cheeks of a user 50 are retracted with the cheek retractor 12 to expose at least one of the teeth of the user 50 (step 104). The tooth whitening composition is applied to the teeth of the user exposed by the cheek retractor (step 106). As shown in FIG. 6B, the tooth whitening composition is preferably applied using a brush applicator 18. Alternatively, the tooth whitening composition can be applied in any suitable manner, using any suitable applicator.

Preferably, an activator composition is also provided and applied to the whitening composition. The activator composition is preferably provided disposed in contact with a film 40 which is applied to the teeth over the whitening composition, as shown in FIG. 6C. Alternatively, the activator composition can be provided integrally with the whitening composition or otherwise added to the whitening composition prior to applying the whitening composition to the teeth of the user. The provided film 40 is preferably a substantially clear polymeric film to allow penetration of light from the light source 14 as described further below.

The light source 14 is removably connected to the cheek retractor 12 (step 108), as shown in FIGS. 6D and 6E, and light is shone from the light source 14 onto the film 40, and preferably through the film onto the teeth of the user (step 110). Preferably, light having a wavelength between about 450 nm and about 510 nm is shone through a substantially transparent film 40 onto the teeth of a user. Preferably, the timer 35 in the power unit 34 is activated when the light is shone, and light is removed from teeth when the audible alarm 37 indicates that a predetermined time period measured by the timer 35 has passed. The cheek retractor 12, light source 14, and film 40 are removed from the user's mouth after the predetermined time period, and the user preferably rinses the whitening composition from the mouth with warm water.

The method 100 of FIG. 7 performed using the elements of the system shown in FIGS. 1-4, 5A-5C and 6A-6E provides for superior teeth whitening. While not intending for the application to be limited by any particular theory of functionality or for the method 100 to be limited by any particular system components, the effectiveness of the method and system can be explained as follows. Referring to the Figures and Tables 1 and 2 above, when the activator film 40 with the activation composition disposed thereon contacts the whitening composition, metal oxides (MnOₓ, TiO₂) in the activation composition accelerate the process of active oxygen. Accordingly, hydrogen peroxide (H₂O₂) in the whitening composition is quickly and substantially completely decomposed into O₂, which is effective in bleaching the teeth of the user. Further, the light source 14 heats the whitening composition, at least in part by heating one or more of the metal oxides, to accelerate the decomposition of H₂O₂ and the generation of O₂. In this manner, a relatively low quantity of hydrogen peroxide (H₂O₂) can be used in the whitening composition, while still achieving effective teeth whitening in a short period of time.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A system for whitening teeth comprising:
a whitening composition comprising an oxidizing compound for application onto teeth of a user;
a cheek retractor for opening lips of a user to facilitate application of the whitening composition onto teeth of a user;
a light source which is at least one of adjustably and removably connectable to the cheek retractor for shining light onto teeth of a user.

2. The system of claim 1, wherein the oxidizing compound is hydrogen peroxide.

3. The system of claim 1, wherein the whitening composition is at least one of a liquid and a gel.

4. The system of claim 1, wherein the oxidizing compound is hydrogen peroxide having a concentration between about 3% and about 12% by weight of the tooth whitening composition and the whitening composition further comprises:
propanediol, having a concentration between about 30% and about 50% by weight of the tooth whitening composition; and
carbomer, having a concentration between about 1% and about 5% by weight of the tooth whitening composition.

5. The system of claim 1, wherein the light source includes a plurality of LEDs having emission wavelengths between about 450 nm and about 510 nm.

6. The system of claim 1, further comprising an activation composition for application onto the whitening composition.

7. The system of claim 6, wherein the activation composition comprises a manganese oxide activator.

8. The system of claim 6, wherein the activation composition comprises a photocatalyzer which comprises titanium dioxide.

9. The system of claim 1, further comprising:
at least one film for application onto the teeth of a user in contact with the whitening composition; and
an activation composition disposed as a layer in contact with the film.

10. The system of claim 9, wherein the film is at least one of a transparent and translucent polymeric film.

11. The system of claim 9, wherein the activation composition comprises a viscous liquid including an activator and a carrier.

12. The system of claim 9, wherein the film is removably hermetically packaged with the activation composition.

13. A device for irradiating the surface of teeth comprising:
a cheek retractor for opening lips of a user; and
a light source which is at least one of removably and adjustably connected to the cheek retractor for shining light onto teeth of a user.

14. The device of claim 13, wherein the light source comprises a plurality of LEDs.

15. The device of claim 13, wherein the cheek retractor comprises a spring portion and at least two lip contact portions connected to the spring portion and outwardly biased by the spring portion.

16. The device of claim 13, further comprising a bite spacer connected to the cheek retractor.

17. The device of claim 13, wherein the cheek retractor comprises at least one connecting portion, and the light source comprises at least one connecting portion, and the at least one connecting portion of the light source removably connects with the at least one connecting portion of the cheek retractor.

18. The device of claim 13, wherein the cheek retractor comprises an opening for accessing exposed teeth of a user of the device, and the light source is removably positioned to direct light through the opening onto exposed teeth of a user of the device.

19. A method for whitening teeth of a user, the method comprising:
providing a cheek retractor, a light source and a tooth whitening composition;
retracting cheeks of a user with the cheek retractor to expose at least one of the teeth of the user;
applying the tooth whitening composition to the at least one of the teeth of the user exposed by the cheek retractor;
removably connecting the light source to the cheek retractor; and
shining light from the light source onto the at least one of the teeth of the user exposed by the cheek retractor.

20. The method of claim 19, further comprising:
providing at least one polymeric film;
providing at least one activation composition in contact with the film; and
connecting the film to the at least one of the teeth in contact with the tooth whitening composition.

21. The method of claim 19, further comprising:
providing the tooth whitening composition with an oxidizing compound;
providing an activation composition including at least one metallic oxide; and
applying the activation composition in contact with the tooth whitening composition.

22. The method of claim 19, further comprising shining light having wavelength between 450 nm and 510 nm from the light source onto the at least one of the teeth of the user for a predetermined period of time.
